(19) United States
(12) Patent Application Publication
(10) Pub. No.: US 2018/0098150 A1
(43) Pub. Date: Apr. 5, 2018

(54) MULTICHANNEL AUDIO INTERCEPTION AND REDIRECTION FOR MULTIMEDIA DEVICES

(71) Applicant: Blackfire Research Corporation, San Francisco, CA (US)

(72) Inventors: Ramachandra Penke, Fremont, CA (US); Ravi Rajapakse, San Francisco, CA (US)

(21) Appl. No.: 15/284,518

(22) Filed: Oct. 3, 2016

(51) Int. Cl. H04R 3/12; G06F 3/16

(52) U.S. Cl. CPC H04R 3/12; G06F 3/162

(57) ABSTRACT

A system and method for multichannel audio interception and redirection for ANDROID™-based devices, comprising an audio redirector software module that detects available hardware capabilities, configures and reports audio channel capabilities based on the detected hardware capabilities, de-multiplexes received audio, and provides de-multiplexed audio channels to both a sound processing framework and external audio rendering hardware.

### CROSS-REFERENCE TO RELATED APPLICATIONS

None.

### BACKGROUND OF THE INVENTION

### Field of the Art

The disclosure relates to the field of mobile devices and applications, and more particularly to the field of audio processing and rendering on devices running an operating system.

### Discussion of the State of the Art

In mobile devices using software operating systems such as the ANDROID™ operating system and derivatives thereof, a hardware abstraction layer (third-party framework) is used to provide connections between high-level application calls and application programming interfaces (APIs) and underlying audio drivers and hardware devices. The underlying operating system kernel generally uses the Advanced Linux Sound Architecture (native audio) audio driver, which has native support for two distinct audio channels, also known as stereo or 2.0 audio.

When audio is requested from an audio provider (such as a media streaming service or other application or service providing audio content), the native audio reports its hardware capabilities so the provider sends suitable content. Because the native audio only has native support for 2.0 audio, audio providers and applications only provider two channels of audio content, even if external audio hardware is present, for example if a user plugs their ANDROID™ device into an audio device supporting 3.1 audio (referring to the presence of three primary audio channels and a subwoofer for low-frequency audio).

What is needed, is a mechanism for intercepting audio request within the third-party framework to identify and report additional audio capabilities when appropriate, that can de-multiplex provided audio content and send 2.0 audio to the native audio for native handling, and send additional audio content to additional hardware devices to enable multi-channel audio on devices that lack this native capability.

### SUMMARY OF THE INVENTION

Accordingly, the inventor has conceived and reduced to practice, in a preferred embodiment of the invention, a system and method for multichannel audio interception and redirection for multimedia devices.

In ANDROID™ devices, software limitations of the native audio processing framework limit audio rendering and playback to two channels for stereo audio, regardless of the actual capabilities of the device or any connected audio hardware. Increasingly, hardware capabilities of mobile devices are being improved such as the addition of multiple speakers and high-definition audio connections for external devices, and ANDROID™-based operating systems are being installed and run on more complex hardware including desktop computing systems that have far more advanced capabilities than can be fully utilized by the native audio. The invention provides a mechanism for intercepting, de-multiplexing (demuxing), and redirecting audio channels to full utilize more complex audio hardware arrangements, that can be deployed as a software module within the Linux operating system that provides the foundation for all ANDROID™ software.

According to a preferred embodiment of the invention, a system for multichannel audio interception and redirection for Android-based devices, comprising: an audio redirector comprising at least a plurality of programming instructions stored in a memory and operating on a processor of a network-connected computing device and configured to connect to a sound processing framework of a Linux-based operating system operating on the computing device, and configured to receive audio media signals from a plurality of hardware and software devices operating on the computing device, and configured to process at least a portion of the audio media signals, the processing comprising at least a de-multiplexing operation that produces a plurality of audio channels, and configured to send at least a portion of the de-multiplexed audio channels to the sound processing framework, and configured to send at least a portion of the de-multiplexed audio channels to a plurality of external hardware devices via a network, is disclosed.

According to another preferred embodiment of the invention, a method for multichannel audio interception and redirection for Android-based devices, comprising the steps of: detecting, using an audio redirector comprising at least a plurality of programming instructions stored in a memory and operating on a processor of a network-connected computing device and configured to connect to a sound processing framework of a Linux-based operating system operating on the computing device, and configured to receive audio media signals from a plurality of hardware and software devices operating on the computing device, and configured to process at least a portion of the audio media signals, the processing comprising at least a de-multiplexing operation that produces a plurality of audio channels, and configured to send at least a portion of the de-multiplexed audio channels to the sound processing framework, and configured to send at least a portion of the de-multiplexed audio channels to a plurality of external hardware devices via a network, audio hardware capabilities of the computing device; configuring audio channels based at least in part on the detected hardware capabilities; reporting audio channels to an audio provider software application; receiving audio from the audio provider software application; de-multiplexing the received audio to produce a plurality of independent audio channels; providing at least a portion of the audio channels to a sound processing framework operating on the computing device; and providing at least a portion of the audio channels to a plurality of external audio hardware devices based at least in part on the detected hardware capabilities, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 (Prior Art) is a prior art block diagram illustrating an exemplary system architecture for audio processing within an ANDROID™-based operating system.

FIG. 2 is a block diagram illustrating an exemplary system architecture for audio interception and redirection within an operating system, according to a preferred embodiment of the invention.

FIG. 2A is a block diagram illustrating an exemplary system architecture for audio interception and redirection within an operating system, illustrating an alternate arrangement utilizing an audio redirector operating within the operating system kernel, according to a preferred embodiment of the invention.

FIG. 2B is a block diagram illustrating an exemplary system architecture for audio interception and redirection within an operating system, illustrating an alternate arrangement utilizing an audio redirector operating within the operating system user space, according to a preferred embodiment of the invention.

FIG. 3 is a flow diagram illustrating an exemplary method for audio interception and redirection within an ANDROID™-based operating system, according to a preferred embodiment of the invention.

FIG. 4 is an illustration of an exemplary usage arrangement, illustrating the use of an ANDROID™-based smartphone with multiple remote speaker devices for multichannel audio playback.

FIG. 5 is an illustration of an exemplary usage arrangement, illustrating the use of an ANDROID™-based media device connected to a television and multiple remote speaker devices for multichannel audio playback while watching a movie.

FIG. 6 is a block diagram illustrating an exemplary hardware architecture of a computing device used in an embodiment of the invention.

FIG. 7 is a block diagram illustrating an exemplary logical architecture for a client device, according to an embodiment of the invention.

FIG. 8 is a block diagram showing an exemplary architectural arrangement of clients, servers, and external services, according to an embodiment of the invention.

FIG. 9 is another block diagram illustrating an exemplary hardware architecture of a computing device used in various embodiments of the invention.

FIG. 10 is an illustration of an additional exemplary usage arrangement, illustrating the use of a smart TV utilizing an audio redirector within its operating system.

### DETAILED DESCRIPTION

The inventor has conceived, and reduced to practice, in a preferred embodiment of the invention, a system and method for multichannel audio interception and redirection for ANDROID™-based devices.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

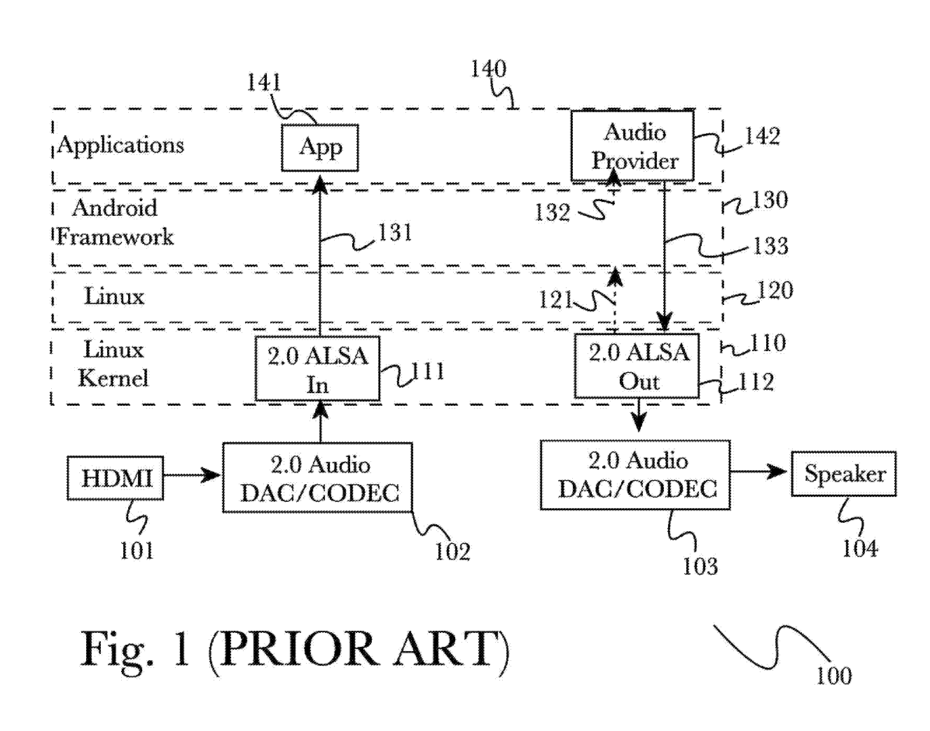

FIG. 1 is a prior art block diagram illustrating an exemplary system architecture 100 for audio processing within an operating system. Some arrangements may use the ANDROID™ operating system, which is based on a version of the Linux operating system 120 and generally tailored for use in mobile devices such as smartphones and tablet computing devices, but is also suitable for use in personal computers, media devices, and other hardware. In an operating system (not specific to ANDROID™) the kernel 110 is a software application that operates the core functionality of the operating system, generally having complete control over the system including hardware devices and software applications. Kernel 110 is loaded when a device is powered on during boot-up, and kernel 110 is responsible for managing the loading of other operating system components during the remainder of the boot-up process. In an ANDROID™ device, the remainder of the ANDROID™ operating system framework 130 is loaded by the kernel during boot-up and provides the android hardware abstraction layer (HAL) for the application layer 140, to expose low-level hardware functionality such as audio processing (for example) to high-level APIs and system calls from installed applications.

In an ANDROID™-based device (and in many other Linux-based operating systems), the kernel 110 manages (among many other things) the Advanced Linux Sound Architecture 111, 112, which comprises a software framework that provides an API for handling audio device drivers. As shown, the native audio 111 may be responsible for processing audio as input 131 to a software application 141 (such as audio received from a connected HDMI multimedia input 101) or as output 133 from an application 142 such as a media application providing audio for playback via a device speaker 104. Generally, any and all audio processing that occurs within the operating system is handled by the native audio 111, 112. In ANDROID™, native audio functionality is limited to two distinct audio channels natively, for providing stereo 2.0 audio via left and right audio channels.

During operation, a 2.0-channel digital/analog converter (DAC) or coder/decoder (CODEC) hardware component 102 is used to receive and de-multiplex (“demux”) incoming audio received from an external source such as an HDMI device 101, and provide the 2.0 audio to native audio 111 for processing and providing 131 to applications 141. If additional audio channels are received, they may be discarded or remuxed into the usable two channels, for example in a 7.1-channel arrangement (generally having discrete audio channels for center, front-left, front-right, left, right, rear-left, rear-right, and a subwoofer), all left audio channels may be combined into a single channel for use in 2.0 audio within the device's capabilities. This results in a loss of audio fidelity, or when remuxing is not performed, audio content may be lost as channels are dropped.

For audio playback from an audio provider 142 such as an application sending audio for playback via a device speaker 104 (for example, a media player application or a game), native audio 112 may report the device's capabilities 121 to the third-party framework 130, which then reports these capabilities 132 to the application 142 so that appropriate content is sent (preventing situations where an application attempts to send audio the device is incapable of rendering, for example). Audio provider application 142 then responds by providing audio content 133 to native audio 112, which directs a 2.0-channel DAC/CODEC hardware component 103 to render the audio output via a connected speaker 104 or other playback device. This avoids unnecessary data from audio that will be dropped (if an application were to send, for example, 5.1-channel audio to the 2.0-capable native audio) and ensures that the audio received and rendered is suitable for the device's specific hardware.

Multimedia files are often stored and streamed using any of a number of container file formats such as (for example) AIFF or WAV for audio-only media, FITS or TIFF for still image media, or flexible container formats such as MKV or MP4 that may contain many types of audio, video, and other media or metadata and may be used to contain, identify, and interleave multiple media data types (for example, for a movie file containing video and audio, potentially with multiple data tracks each). These containers do not describe how the data they contain is encoded, and must be decoded by a decide in order to render the media, via CODEC 102, 103. A CODEC 102, 103 decodes the container format and provides the contained media streams to appropriate handlers for rendering, such as native audio 111 or a hardware rendering device such as speaker 104.

In the OS kernel 110, the native audio 111, 112 manages all sound features in the system and facilitates connections between hardware and applications through the third-party framework 130. Native audio 111, 112 supports only 2.0-channel audio however, resulting in any audio within the system being bottlenecked to two channels when it passes through the native audio during processing.

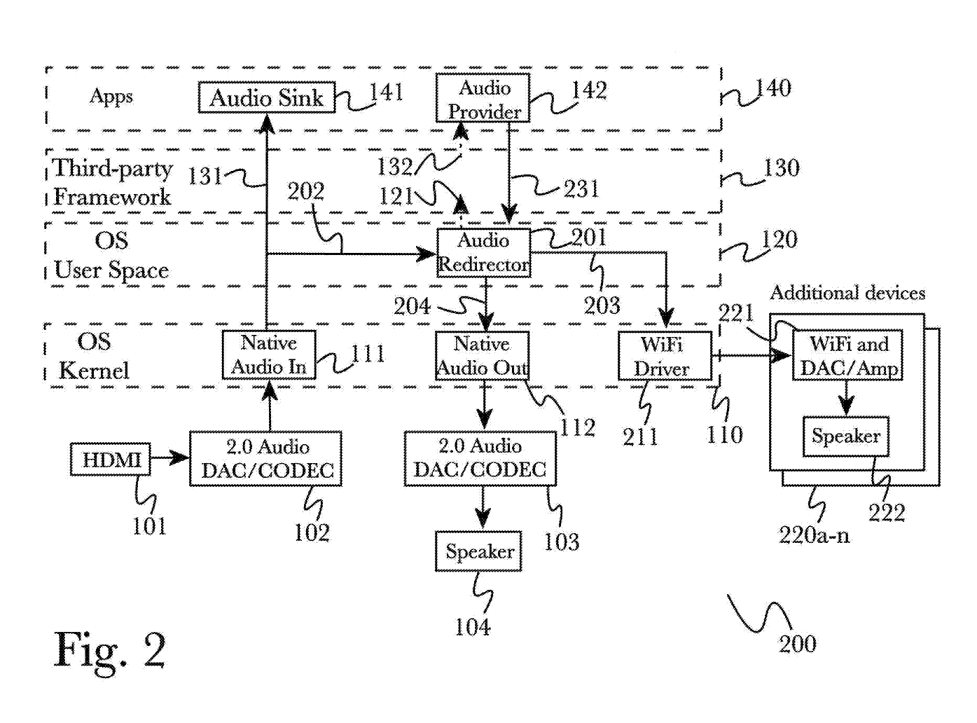

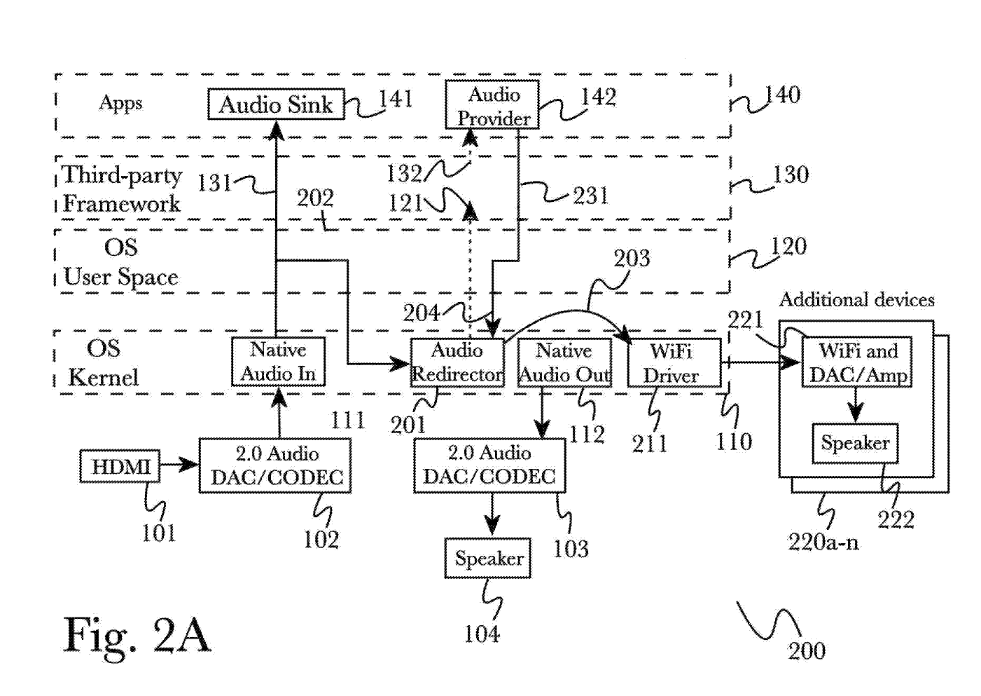

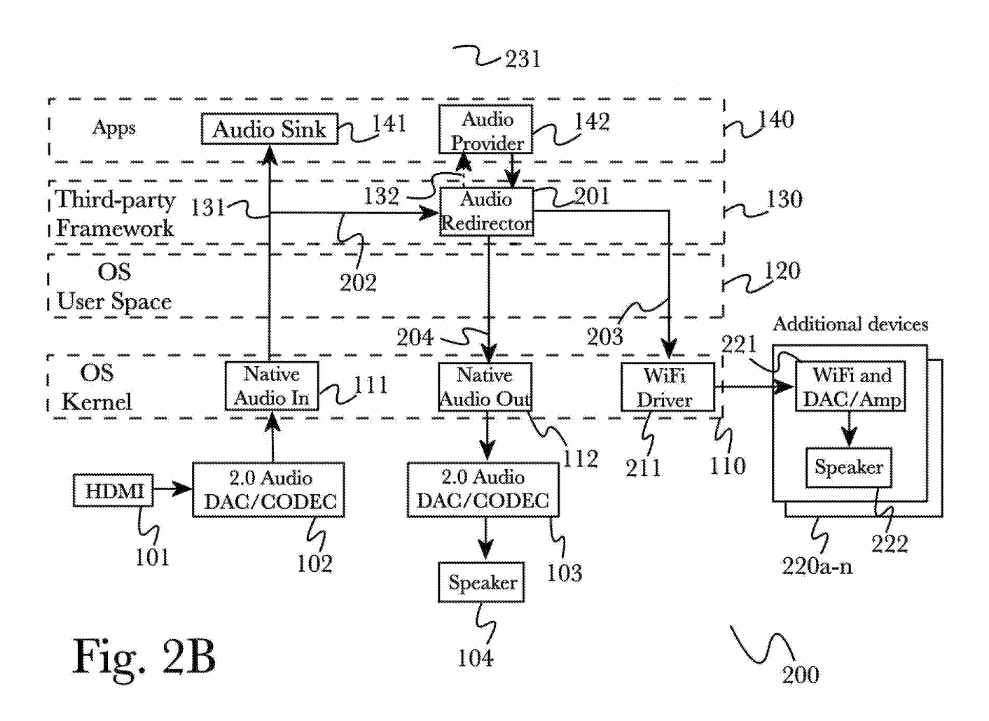

FIG. 2 is a block diagram illustrating an exemplary system architecture 200 for audio interception and redirection within an operating system, according to a preferred embodiment of the invention. According to the embodiment, an audio redirector software component 201 may be deployed within the Linux OS layer 120 and used to intercept and redirect audio streams while retaining use of native audio 112 for natively handling two channels for uninterrupted normal operation. With inbound audio (for example, from a connected HDMI source 101), the audio signal may be intercepted by audio redirector 201 as part of a full-capture operation mode wherein all system audio passes through the audio redirector 201 in a manner similar the native audio 111, 112 to ensure complete functionality. When rendering audio, rather than relying on native audio 112 to report device capabilities, audio redirector 201 reports directly 121 to the abstraction layer 130 which is relayed via appropriate APIs 132 to an application 142 such as a media streaming service, music player application, game, or other audio provider. This enables audio redirector 201 to identify a device's full hardware capabilities, which may extend beyond the native 2.0 audio processing provided by native audio 111, 112 alone. For example, a number of external speakers 220a-n may be connected, such as via a WiFi data network for wireless music streaming. These devices would be known to the operating system, generally by their network addresses and hardware capabilities, and this information may be recognized and reported by audio redirector 201 to incorporate these speakers for use as additional audio channels according to their capabilities or arrangement.

When audio is provided by an audio provider application 142, the stream is intercepted 231 by audio redirector 201 without passing through the native audio 112 (as the audio redirector 201 resides in the operating system 120 effectively “above” the native audio 112 in terms of system abstraction). Audio redirector 201 then processes the audio signal and separates the received channels, passing up to two channels 204 to native audio 112 for native processing, handling by a hardware DAC/CODEC 103, and rendering on a device speaker 104. Additional audio channels may be provided 203 to other systems for handling, such as a device WiFi driver 211 that operates a wireless network connection to a plurality of external speaker devices 220a-n, so that additional audio channels may be transmitted to these speakers 220a-n for processing via their own DAC or amplifier 221 and rendering via their speaker hardware 222. In this manner, use of an audio redirector 201 provides for greatly improved audio rendering capabilities and more flexibility as an ANDROID™-based device can now adaptively configure its audio rendering to incorporate additional hardware. Additional channels may be used for more immersive or precise audio, such as for immersive gaming with audio channels to precisely indicate the source of an in-game sound, media consumption with multiple audio channels to improve the quality and enjoyment of a movie or music listening experience, or audio production where additional audio channels may be used to provide a more precise monitoring system while creating audio content or for monitoring playback such as for a DJ using an ANDROID™ device.

FIG. 2A is a block diagram illustrating an exemplary system architecture 200 for audio interception and redirection within an operating system, illustrating an alternate arrangement utilizing an audio redirector 201 operating within the operating system kernel 110, according to a preferred embodiment of the invention. According to the embodiment, an audio redirector software component 201 may be deployed within the operating system kernel 110 and used to intercept and redirect audio streams while retaining use of native audio 112 for natively handling two channels for uninterrupted normal operation. With inbound audio (for example, from a connected HDMI source 101), the audio signal may be intercepted by audio redirector 201 as part of a full-capture operation mode wherein all system audio passes through the audio redirector 201 in a manner similar the native audio 111, 112 to ensure complete functionality. When rendering audio, rather than relying on native audio 112 to report device capabilities, audio redirector 201 reports directly 121 to the abstraction layer 130 which is relayed via appropriate APIs 132 to an application 142 such as a media streaming service, music player application, game, or other audio provider. This enables audio redirector 201 to identify a device's full hardware capabilities, which may extend beyond the native 2.0 audio processing provided by native audio 111, 112 alone. For example, a number of external speakers 220a-n may be connected, such as via a WiFi data network for wireless music streaming. These devices would be known to the operating system, generally by their network addresses and hardware capabilities, and this information may be recognized and reported by audio redirector 201 to incorporate these speakers for use as additional audio channels according to their capabilities or arrangement.

FIG. 2B is a block diagram illustrating an exemplary system architecture 200 for audio interception and redirection within an operating system, illustrating an alternate arrangement utilizing an audio redirector 201 operating within the operating system user space 120, according to a preferred embodiment of the invention. According to the embodiment, an audio redirector software component 201 may be deployed within the operating system user space 120 and used to intercept and redirect audio streams while retaining use of native audio 112 for natively handling two channels for uninterrupted normal operation. With inbound audio (for example, from a connected HDMI source 101), the audio signal may be intercepted by audio redirector 201 as part of a full-capture operation mode wherein all system audio passes through the audio redirector 201 in a manner similar the native audio 111, 112 to ensure complete functionality. When rendering audio, rather than relying on native audio 112 to report device capabilities, audio redirector 201 may communicate directly (optionally using appropriate APIs as needed) 132 with an application 142 such as a media streaming service, music player application, game, or other audio provider. This enables audio redirector 201 to identify a device's full hardware capabilities, which may extend beyond the native 2.0 audio processing provided by native audio 111, 112 alone. For example, a number of external speakers 220a-n may be connected, such as via a WiFi data network for wireless music streaming. These devices would be known to the operating system, generally by their network addresses and hardware capabilities, and this information may be recognized and reported by audio redirector 201 to incorporate these speakers for use as additional audio channels according to their capabilities or arrangement

### Detailed Description of Exemplary Embodiments

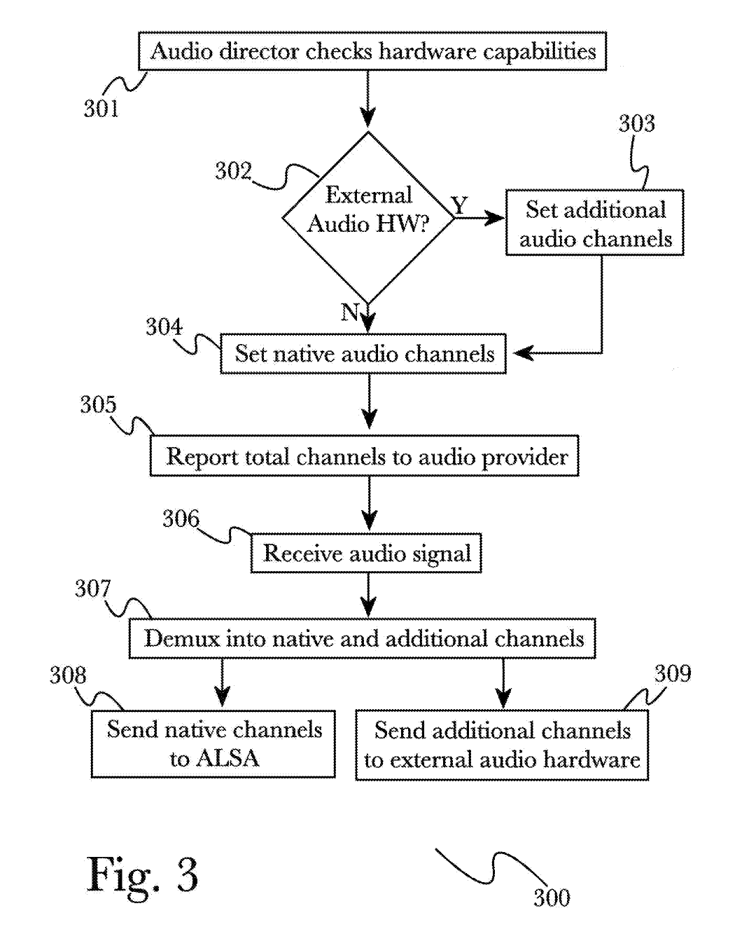

FIG. 3 is a flow diagram illustrating an exemplary method 300 for audio interception and redirection within an operating system, according to a preferred embodiment of the invention. In an initial step 301, an audio redirector 201 may check a device's hardware capabilities to configure its reporting appropriately, so that it reports the correct functionality to the abstraction layer 130 for use in providing audio for rendering. As part of this configuration process, audio redirector 201 may check 302 for any connected external audio hardware, such as connected speakers or microphones via wired or wireless communication interfaces. If external hardware is found, audio redirector 201 may configure a number of additional audio channels 303 based on the nature of the detected hardware. For example, a single connected speaker may result in a single additional audio channel, but a connected sound bar device with 3.1 capabilities may result in configuration of up to 3.1 additional channels in addition to the device's native 2.0 audio. Whether or not external hardware is found, audio redirector 201 may configure up to two channels for the device's native capability 304, as driven by the operating system's native audio 111, 112 capabilities.

For rendering audio, the total channel capability configured in audio redirector 201 may be reported 305 to the abstraction layer 130, so that applications are informed of any expanded capability due to connected external hardware and media sent may be suitable for rendering using the full expanded capabilities available. Audio redirector 201 then receives audio content 306 from an application 141 such as a media player or game, demuxes the audio to separate the channels 307, and sends up to two channels (generally the “left” and “right” channels in a stereo setup, but it should be appreciated that any two channels in a multi-channel arrangement may be used in this manner) to the native audio 308 for native processing and rendering via the device's native hardware (such as a smartphone or tablet's integrated hardware speakers), while simultaneously sending any additional channels to external audio hardware 309 for rendering according to that hardware's known capabilities, for example to produce a 5.1-channel audio arrangement for greater immersion and precision in audio rendering than could be provided via the native 2.0 audio hardware alone. Additionally, it should be appreciated that an audio redirector 201 may transmit audio to external hardware according to the external hardware's capabilities, which in some arrangements may involve decoding a container format and re-encoding into a different format for use, for example if a connected speaker reports native compatibility with MP3 format media but media is received in a different format at audio redirector 201. In this manner, audio redirector 201 may operate as a software CODEC to provide full functionality while demuxing audio for multi-channel rendering via native and external hardware devices.

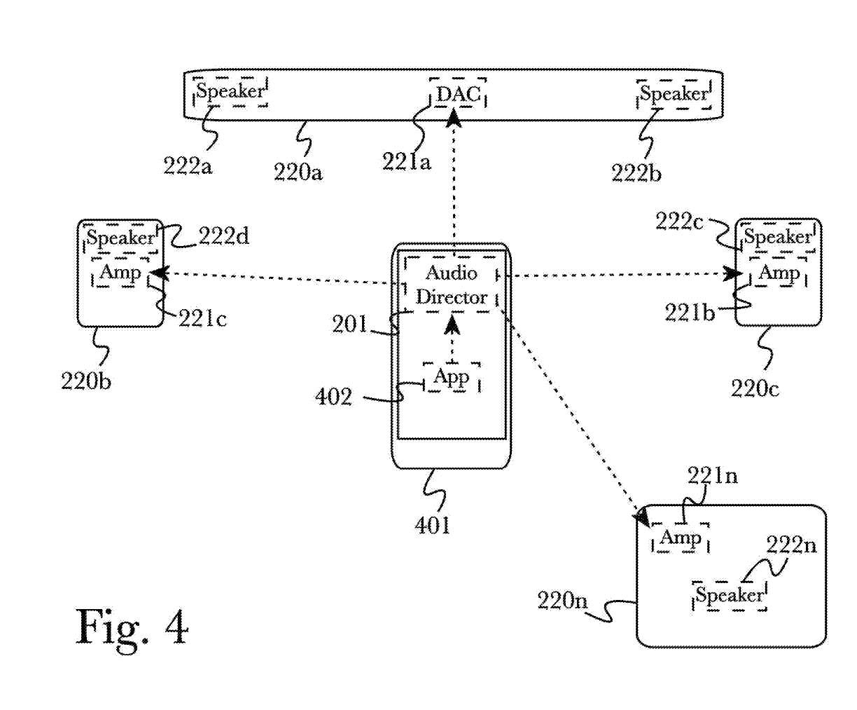

FIG. 4 is an illustration of an exemplary usage arrangement, illustrating the use of an ANDROID™ smartphone 401 with multiple remote speaker devices 220a-n for multichannel audio playback. According to the embodiment, a smartphone 401 running an ANDROID™-based operating system may operate an audio redirector 201 as described above (with reference to FIG. 2), that receives audio from applications 402 operating on the smartphone 401 and sends additional audio channels to external hardware for rendering. Audio may be transmitted wirelessly (for example, using WiFi or BLUETOOTH™, or any other wireless protocol shared between devices) to a plurality of external speakers 220a-n, such as a sound bar 220a, satellite speakers 220b-c, or a subwoofer 220n. Audio may be received and processed by external devices using their own DAC or amplifier 221a-n, and processed for rendering via their onboard speaker hardware 222a-n. In this manner, an ANDROID™-based smartphone 401 may be connected to a number of external audio devices 220a-n that may accurately render multichannel audio from an application 402 operating on the smartphone 401, providing enhanced audio capabilities compared to what may be offered by smartphone 401 alone.

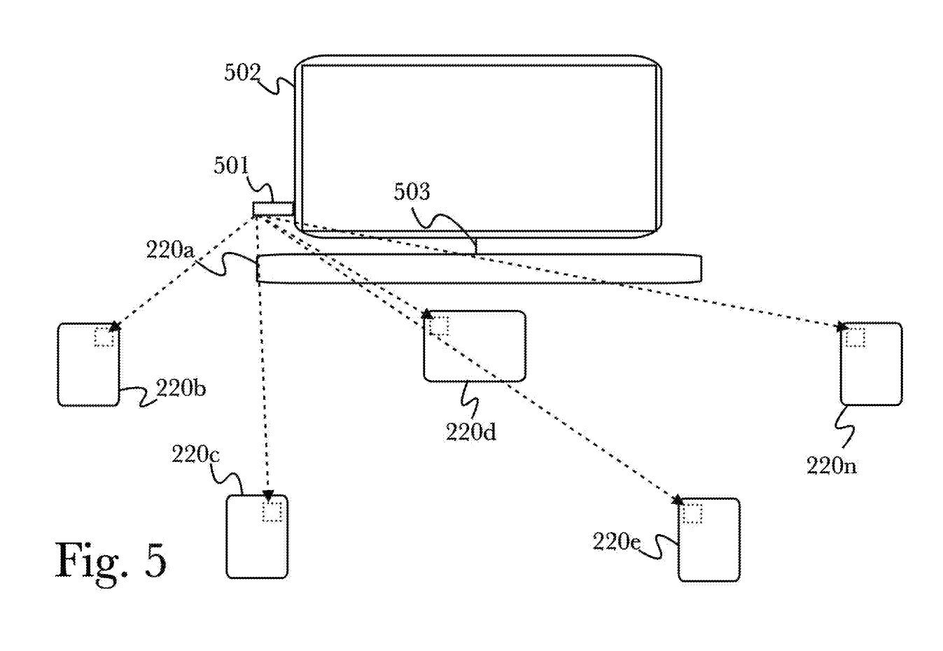

FIG. 5 is an illustration of an exemplary usage arrangement, illustrating the use of an ANDROID™ media device 501 connected to a television 502 and multiple remote speaker devices 220a-n for multichannel audio playback while watching a movie. According to the embodiment, an ANDROID™-based media device 501 such as a CHROMECAST™ or similar media device may be connected to a television 502 for playing media over an HDMI or similar multimedia connection. Ordinarily, due to the inherent limitations of the native audio in ANDROID™ as discussed above (referring to FIGS. 1-2), audio would be limited to 2.0 channels and would be a simple stereo arrangement broadcast to any connected speakers using the television's connections and audio processing to transmit the audio content to connected hardware. Through the use of an audio redirector 201 on media device 501, audio content may comprise multiple channels to fully utilize available hardware, and audio processing and transmission may be at least partially handled by media device 501 as illustrated. A portion of audio channels may be transmitted via the physical connection to television 502 for rendering using attached speakers such as a sound bar 220a connected via a physical audio connector 503 such as S/PDIF audio connection, while additional audio channels may be broadcast separately over wireless protocols such as WiFi or BLUETOOTH™ to a plurality of satellite speaker devices 220b-n, using onboard wireless hardware of media device 501. As illustrated, this may be used to provide a single audio arrangement with multiple channels such as a 5.1-channel setup using front 220a, left 220b and right 220n, rear-left 220c and rear-right 220e, and a subwoofer 220d audio channels according to the available rendering hardware. In this manner, the capabilities of audio rendering hardware may be fully utilized for optimum playback, rather than simplifying the audio being rendered due to software limitations of a media device 501, enabling ANDROID™-powered home theater and other complex multimedia setups to fully utilize multichannel audio playback arrangements.

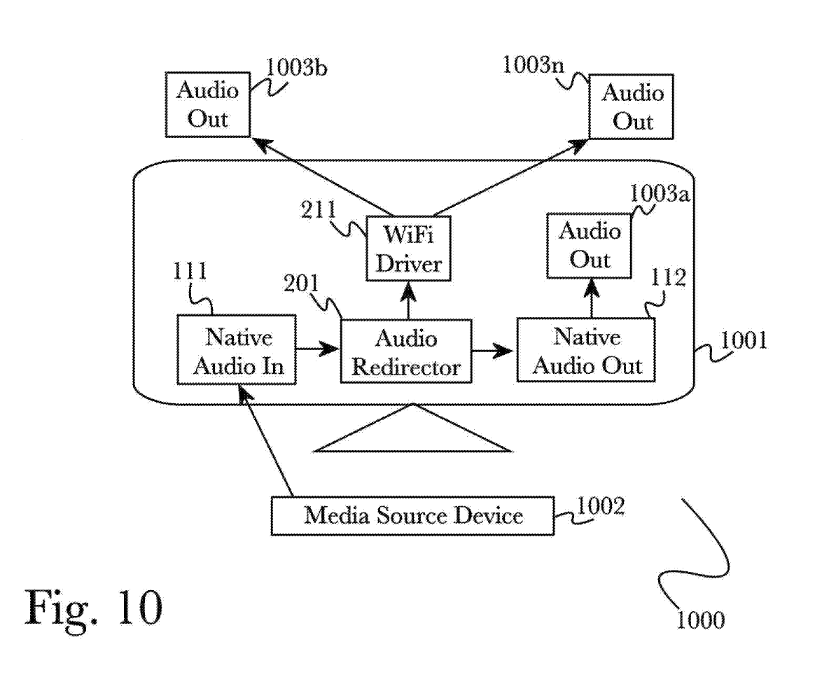

FIG. 10 is an illustration of an additional exemplary usage arrangement 1000, illustrating the use of a smart TV 1001 utilizing an audio redirector 201 within its operating system. According to the embodiment, a Smart TV 1001 may have native audio input 111 and output 112 capabilities such as various hardware controllers and physical connection ports, and may have integral audio output 1003a capabilities such as via internal speakers. According to the embodiment, an audio redirector 201 may be used to intercept audio received via native audio input 111 from a media source device 1002 (such as, for example, a set-top box or a streaming media device such as CHROMECAST™ or ROKU™), splitting the audio to send a portion to native audio output handler 112 for playback via integral audio output hardware 1003a, and sending a portion to a WiFi driver 211 that may then transmit media to network-connected audio output devices 1003b-n, for example to send different audio channels to specific hardware speakers to facilitate a surround sound playback experience, or to send a single audio media stream to multiple speakers for playback in different locations or to increase playback quality. In this manner, is may be appreciated that the functionality provided by audio redirector 201 may be included as an integral part of a device such as a television, without the need for connection or configuration of additional hardware or software components.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

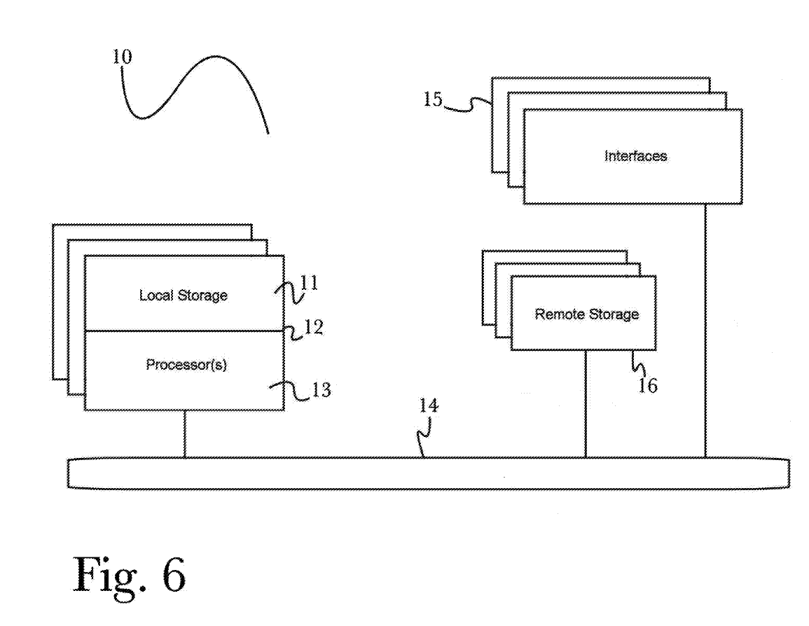

Referring now to FIG. 6, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 6 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

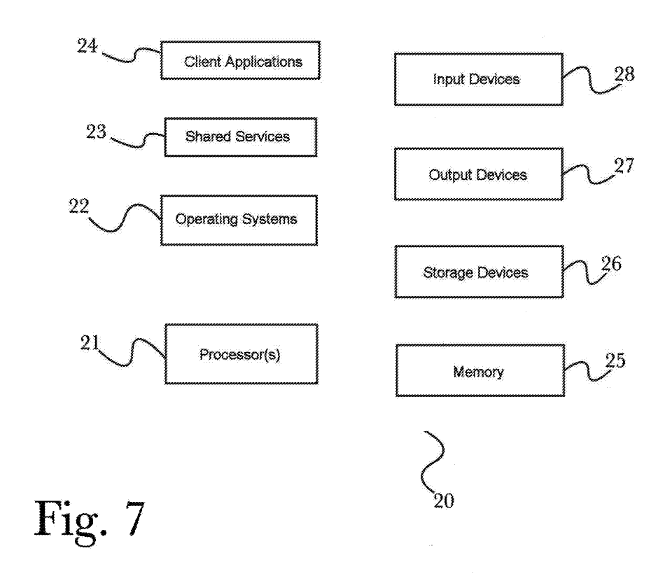

In some embodiments, systems according to the present invention may be implemented on a standalone computing system. Referring now to FIG. 7, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 6). Examples of storage devices 26 include flash memory, magnetic hard drive, CD-ROM, and/or the like.

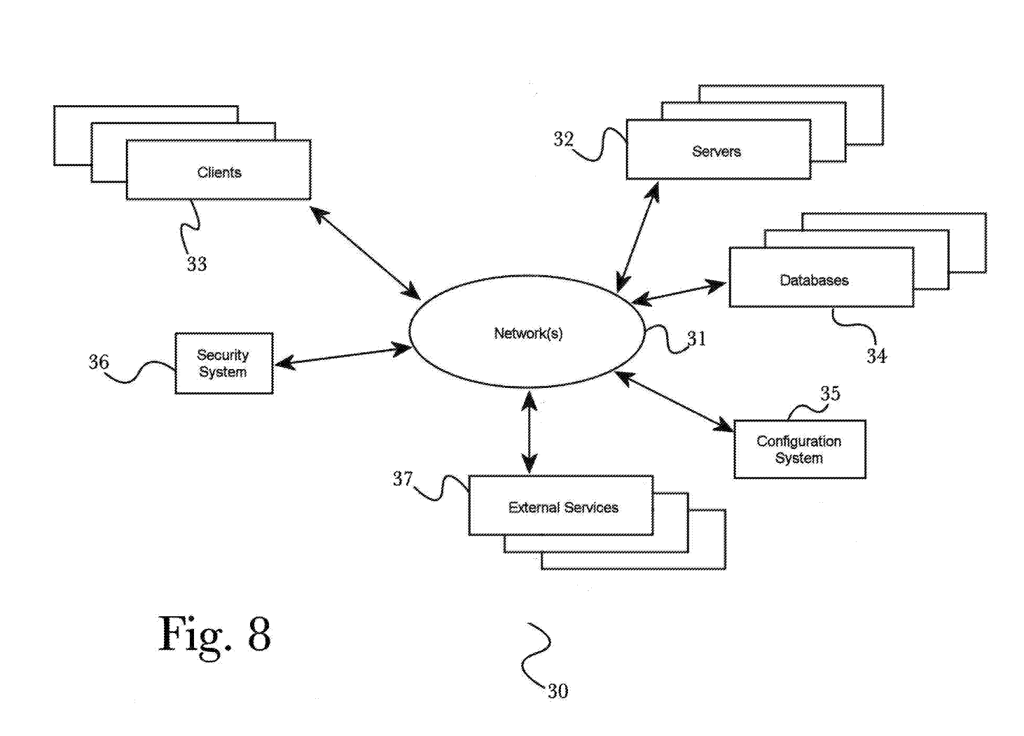

In some embodiments, systems of the present invention may be implemented on a distributed computing network, such as one having any number of clients and/or servers. Referring now to FIG. 8, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 7. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

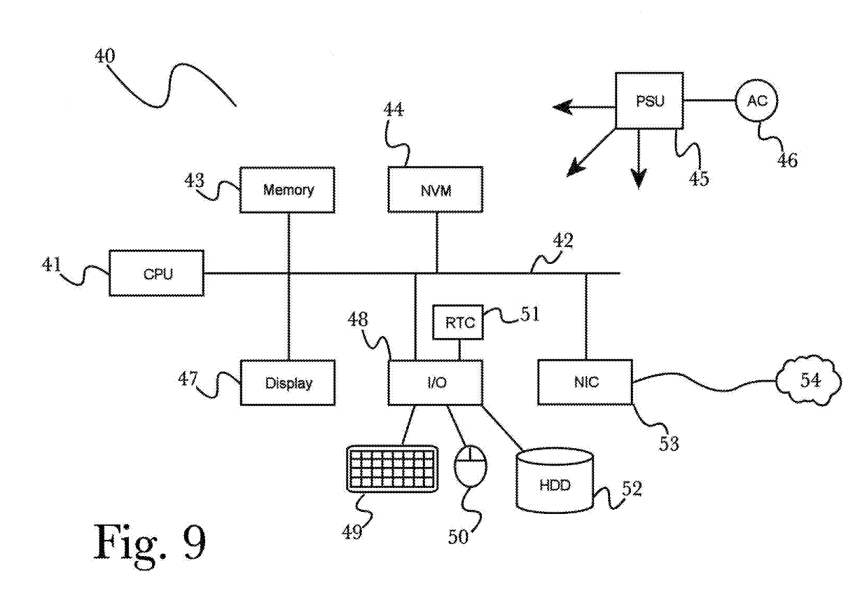

FIG. 9 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A system for multichannel audio interception and redirection for multimedia devices, comprising:
an audio redirector comprising at least a plurality of programming instructions stored in a memory and operating on a processor of a network-connected computing device and configured to:
connect to a sound processing framework of an operating system operating on the computing device;
receive an audio stream from an audio source;
process at least a portion of the audio stream, the processing comprising at least a de-multiplexing operation that produces a plurality of audio channels;
send at least a portion of the de-multiplexed audio channels to the sound processing framework for playback on the computing device; and
send at least a portion of the de-multiplexed audio channels to a plurality of external audio playback devices via a network for playback on the plurality of external audio playback devices.

2. The system of claim 1, wherein the sound processing framework is the Advanced Linux Sound Architecture.

3. The system of claim 2, wherein the operating system is an ANDROID™ operating system.

4. A method for multichannel audio interception and redirection for mobile devices, comprising the steps of:
detecting, using an audio redirector comprising at least a plurality of programming instructions stored in a memory and operating on a processor of a network-connected computing device, audio hardware capabilities of the computing device;
configuring audio channels based at least in part on the detected hardware capabilities;
reporting audio channels to an audio source;
receiving an audio stream from the audio source;
de-multiplexing the received audio stream to produce a plurality of independent audio channels;
providing at least a portion of the audio channels to a sound processing framework operating on the computing device for playback on the computing device; and
providing at least a portion of the audio channels to a plurality of external audio playback devices based at least in part on the detected hardware capabilities for playback on the plurality of external audio playback devices.
